(19) United States
(12) Patent Application Publication
(10) Pub. No.: US 2011/0266442 A1
(43) Pub. Date: Nov. 3, 2011

(54) Electronic Whiteboard with Mosaic Structure

(75) Inventor: Yinhu ZHANG, Shenzhen (CN)

(73) Assignee: VSON TECHNOLOGY CO., LTD, Shenzhen (CN)

(21) Appl. No.: 12/796,947

(22) Filed: Jun. 9, 2010

(30) Foreign Application Priority Data
Apr. 29, 2010 (CN) 201020176635.4

(51) Int. Cl. G01J 5/00

(52) U.S. Cl. 250/338.1

(57) ABSTRACT

The invention discloses a mosaic structure of the electronic white board, including infra-red rectangular box and back board formed infrared matrix. The infra-red rectangular box is mainly composed of matching combination of infrared transmitter and infrared receiving unit connected and fixed to back board. The infrared transmitter includes several splicing of electrical infrared emission units, and the infrared emission units involve PCB and linear array of infrared emission heads. The infrared receiving unit includes several electrical splicing of infrared receiving modules. The infrared receiving module involves PCB and linear array of infrared receiving heads corresponding with emission heads. The electronic whiteboard rectangular box can be standardized in production, increasing efficiency and reduces costs. You can splice the corresponding size according to the projector requirements. It is convenient and practical. For transportation, you can uninstall the infra-red whiteboard with infra-red rectangular box, which is easy to transport with small space.

### TECHNICAL FIELD

The patent relates to a whiteboard, in particular, relates to a splicing structure of the whiteboard with any kinds of sizes.

### BACKGROUND ART

The infra-red electronic whiteboard using available technologies typically include infra-red rectangular box and back board formed infrared matrix. Four sides of infra-red rectangular box are integrated structure, the rectangular box production scheduled to die by the manufacturers, which the sizes can not be changed and causes inconvenient transport and use, it also increases production and transportation costs and reduce productivity. It is not suitable for standardized production. Therefore, further improvement is necessary.

### CONTENTS OF THE INVENTION

The patent is intended to overcome the deficiencies of existing technologies to provide a mosaic structure of electronic whiteboard splicing different sizes. This splicing mosaic structure is able to reach standardized production, improve production efficiency. It is easy to transport.

To achieve this purpose, the invention adopts the following technical solutions:

A mosaic structure of the electronic whiteboard includes:

The infrared transmitter includes a number of splicing of electrical infrared emission units, and the infrared emission units involve printed circuit board (hereinafter refers to as “PCB”) and linear array of infrared emission heads;

The infrared receiving unit includes a number of electrical splicing of infrared receiving modules, while the infrared receiving module involves PCB and linear array of infrared receiving heads that corresponding with the emission heads;

The infra-red rectangular box is mainly composed of matching combination of infrared transmitter and infrared receiving unit forming infra-red matrix;

Frame cover is mainly composed of the number of mosaic-like cover body cells, it covered access to infra-red rectangular box;

Back board is mainly used for fixing infrared rectangular box and frame cover, and as a projection screen.

Both ends of each strip PCB board of the infra-red receiving unit as described and infra-red emission units are seated with cable connection, the cable connection can get through electrical connections by the flexible wires.

Strip PCB board corresponding to a angle of the infra-red rectangular box respectively set to intersection angles connected with PCB board, the connection of intersection angles and PCB board is equipped with control circuitry.

The described infra-red rectangular box also includes a number of mosaic structure of the frame cover, the frame cover is designed with strip slots that corresponding to strip PCB board, the strip PCB board is covered within the strip slots.

An end of the frame cover is set to plug connector at one end, and the other end equipped with the slot for connector.

The frame cover corresponding to four angles of the infra-red rectangular box are set corner junctions of the frame cover respectively, and those junctions respectively match with plug connector and slots of the frame cover.

The described infra-red rectangular box is fixed on the back board by screws, the screw head is designed with screw plug.

The described infra-red rectangular box is fixed on the back board by double-sided adhesive foam.

Owing to adopting such structure, this new type of electronic whiteboard rectangular box can be standardized in production, which increases production efficiency and reduces production costs. You can splice the corresponding size according to the projector requirements. It is so convenient and practical. In the transport process, you also are able to uninstall the infra-red whiteboard with infra-red rectangular box, and it is easy to transport by sharing small space.

### DESCRIPTION OF FIGURES

FIG. 1 Structure-based diagram of this invention;

FIG. 2 Enlarged diagram of part A of FIG. 1;

FIG. 3 Structure-based diagram of another implement ways of the invention;

FIG. 4 Enlarged diagram of part B of FIG. 3.

### MODE OF CARRYING OUT THE INVENTION

The attaches figures and specified implement ways to the detailed description of this invention are as the followings:

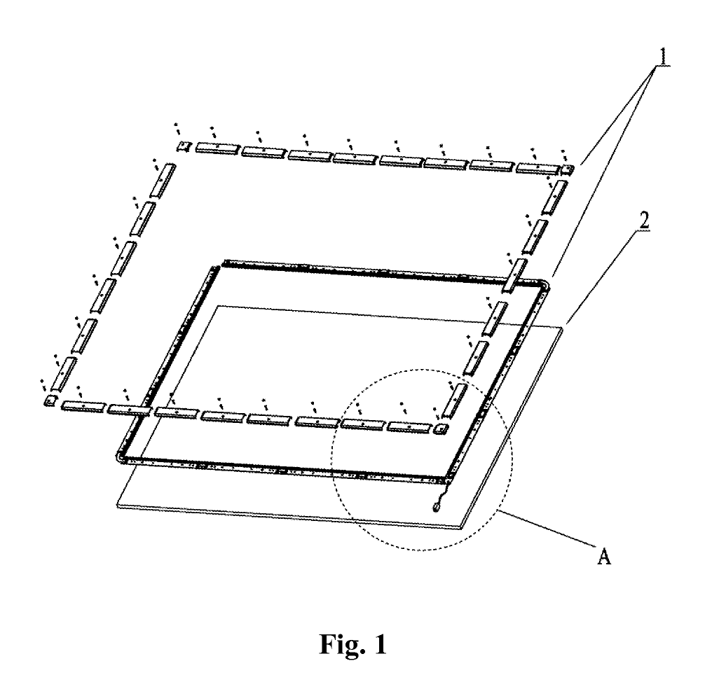

From FIG. 1 to FIG. 4, it indicates that a mosaic structure of the electronic white board, including infra-red rectangular box 1 and back board 2 formed the infrared matrix. The infra-red rectangular box 1 is mainly composed of matching combination of infrared transmitter and infrared receiving unit connected and fixed to the back board 2. The infrared transmitter includes a number of splicing of electrical infrared emission units, and the infrared emission units involve PCB 3. Both ends of the PCB 3 are set to cable connection 4, the cable connection 3 can get through electrical connections by the flexible wires 7, and linear array on strip PCB 3 are infrared emission heads 13. The infrared receiving unit includes a number of electrical splicing of infrared receiving modules. The infrared receiving module involves PCB 3 and linear array of infrared receiving heads 14 that corresponding with the emission heads 13. Strip PCB board 3 corresponding to a angle of the infra-red rectangular box respectively set to intersection angles connected with PCB board 5, the connection of intersection angles of PCB board 5 is equipped with control circuitry which connects to the computer through USB interface 6. The infra-red rectangular box 1 also includes a number of mosaic structure of the frame cover 8, the frame cover 8 is designed with strip slots that corresponding to strip PCB board 3, the strip PCB board 3 is covered within the strip slots. An end of the frame cover 8 is set to plug connector at one end, and the other end equipped with the slot for connector. The frame cover 8 corresponding to four angles of the infra-red rectangular box are set corner junctions 9 of the frame cover 8 respectively, and those junctions 9 respectively match with plug connector and slots of the frame cover.

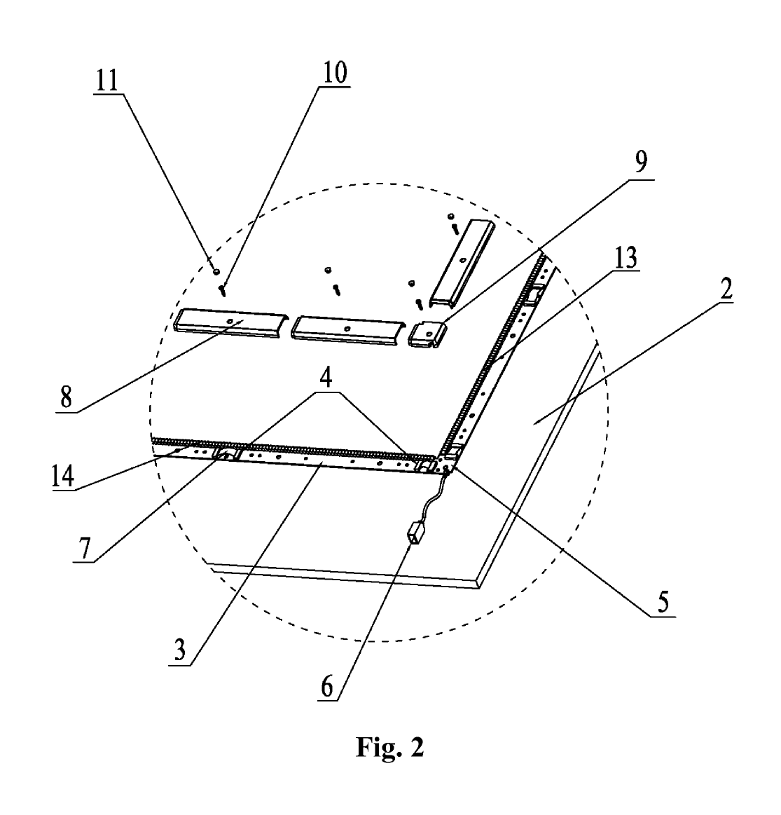

In the implementation of the first approach, the infra-red rectangular box 1 is fixed on the back board by screws 10, the screw head is designed with screw plug 11, shown as in FIG. 1 and FIG. 2.

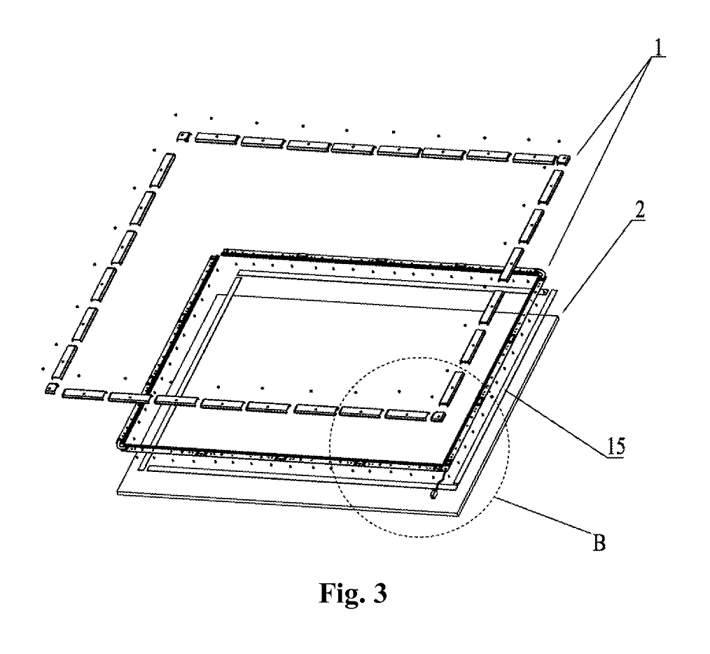

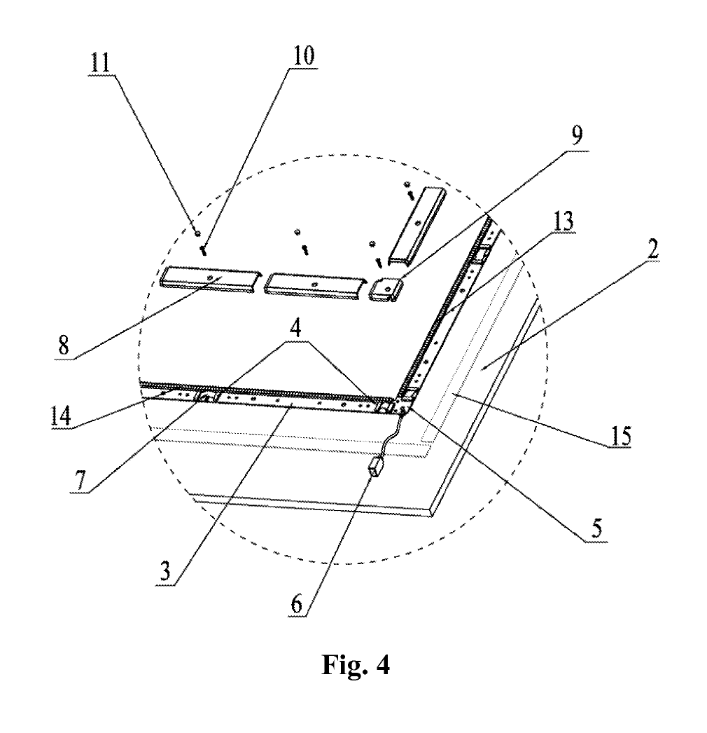

In the implementation of the second approach, the infra-red rectangular box is fixed on the back board by double-sided adhesive foam 15, shown as in FIG. 3 and FIG. 4.

What is claimed is:

1. A kind of mosaic structure of the electronic whiteboard includes:
The infrared transmitter includes a number of splicing of electrical infrared emission units, and the infrared emission units involve printed circuit board and linear array of infrared emission heads;
The infrared receiving unit includes a number of electrical splicing of infrared receiving modules, while he infrared receiving module involves printed circuit board and linear array of infrared receiving heads that corresponding with the emission heads;
The infra-red rectangular box is mainly composed of matching combination of infrared transmitter and infrared receiving unit forming infra-red matrix;
Frame cover is mainly composed of the number of mosaic-like cover body cells, it covered access to infra-red rectangular box;
Back board is mainly used for fixing infrared rectangular box and frame cover, and as a projection screen.

2. According to the mosaic structure of the electronic whiteboard described in claim 1, the characteristics: both ends of each strip printed circuit board of the infra-red receiving unit as described and infra-red emission units are seated with cable connection, the cable connection can get through electrical connections by the flexible wires.

3. According to the mosaic structure of the electronic whiteboard described in claim 1, the characteristics: strip printed circuit board corresponding to a angle of the infra-red rectangular box respectively set to intersection angles connected with printed circuit board, the connection of intersection angles and P printed circuit board is equipped with control circuitry.

4. According to the mosaic structure of the electronic whiteboard described in claim 2, the characteristics: strip printed circuit board corresponding to a angle of the infra-red rectangular box respectively set to intersection angles connected with printed circuit board, the connection of intersection angles and printed circuit board is equipped with control circuitry.

5. According to the mosaic structure of the electronic whiteboard described in claim 1, the characteristics: the described frame cover is designed with strip slots that corresponding to strip printed circuit board, the strip printed circuit board is covered within the strip slots.

6. According to the mosaic structure of the electronic whiteboard referred to claim 5, the characteristics: an end of the frame cover is set to plug connector at one end, and the other end equipped with the slot for connector.

7. According to the mosaic structure of the electronic whiteboard referred to claim 6, the characteristics: the frame cover corresponding to four angles of the infra-red rectangular box are set corner junctions of the frame cover respectively, and those junctions respectively match with plug connector and slots of the frame cover.

8. According to the mosaic structure of the electronic whiteboard described in claim 1, the characteristics: the described infra-red rectangular box is fixed on the back board by screws, the screw head is designed with screw plug.

9. According to the mosaic structure of the electronic whiteboard described in claim 1, the characteristics: the described infra-red rectangular box is fixed on the back board by double-sided adhesive foam.
